(19) United States
(12) Patent Application Publication
(10) Pub. No.: US 2007/0288771 A1
(43) Pub. Date: Dec. 13, 2007

(54) Source Separator for Power over Ethernet Systems

(76) Inventor: Steven Andrew Robbins, (US)

Correspondence Address: Steve Robbins;Unit A, 26007 Alizia Canyon Drive, Calabasas, CA, 91302, US

(21) Appl. No.: 11/539,622

(22) Filed: Oct. 6, 2006

Related U.S. Application Data
(60) Provisional application No. 60/804,215, filed on Jun. 8, 2006.

(51) Int. Cl. G06F 1/26

(52) U.S. Cl. 713/300

(57) ABSTRACT

A method and apparatus with several embodiments for separating power supplied by two Power Sourcing Equipment (P SE) for Power over Ethernet (PoE) systems, for the purpose of providing power to a two separate Powered Devices (PD) over a single network cable. A first PD runs off power supplied by an endspan PSE, and a second PD runs off power supplied by a midspan PSE. An Ethernet hub, switch, or repeater circuit is also included to allow both PD's to communicate with the endspan PSE.

### CROSS- REFERENCE TO RELATED APPLICATIONS

This application claims priority from US Provisional Patent Application number 60804215 titled A Passive Separator for PoE Power Sources filed on Jun. 8, 2006.

### TECHNICAL FIELD OF THE INVENTION

The invention relates generally to the field of Power over Ethernet (PoE): a system that provides power over computer networking cables.

### BACKGROUND OF THE INVENTION

The IEEE issued an amendment to IEEE Std 802.3™-2002; this amendment, titled Data Terminal Equipment (DTE) Power via Media Dependent Interface (MDI), was published as IEEE Std 802.3af™-2003, and is hereinafter referred to as the “IEEE standard”. The IEEE standard, whose contents are incorporated herein by reference, is commonly referred to as Power over Ethernet (PoE), and specifies methods and requirements for delivery of limited DC power using two of the four twisted-pairs contained within standard Ethernet cables. Equipment that supplies power on Ethernet cables are called Power Sourcing Equipment (PSE), of which there are two types, endspan and midspan, distinguishable by their location within the link segment. Any apparatus that utilizes power supplied by a PSE is called a Powered Device (PD).

The most common PoE installation is an office building with a single PD (an Internet Protocol telephone) in every office, and a central PSE that powers all the PD's. Network cables radiate out from the PSE to all the PD's in the building, often running long distances through plenums, and sometime passing through walls or floors; installing such cables often requires electricians or other trained professionals, sometimes at considerable expense. A user who wishes to have a second PD in his office would normally need to run a second network cable through the building; the problem is that the cost of installing this additional cable can easily exceed the cost of the PD itself.

The prior art describes one approach to this problem: a “PoE hub”. FIG. 1 depicts a block diagram of a system 10 that includes: a PSE 11; a PoE hub 12; two PD's 13 and 14; and three cables 15, 16, and 17. (The cables 15 through 17 carry both Ethernet data and power, but for simplicity FIG. 1 shows only the flow of power, indicated by the arrows.) The PSE 11 supplies power to the PoE hub 12 via cable 15 (which can be up to 100 meters long). The PoE hub 12 contains an internal PD 18 which receives power from the PSE 11, and uses some of that power to run its internal Ethernet hub 19; the surplus power is available to run the two external PD's 13 and 14 via the internal PSE 20. The Ethernet hub 19 allows both PD's 13 and 14 to communicate with the PSE 11.

The biggest disadvantages of the PoE hub are cost and efficiency. The PoE hub is expensive because it must contain a lot of complex circuitry, including a power supply large enough to run all the external PD's. A significant portion of the power from the remote PSE is wasted in the conversion process and to power the PoE hub's internal circuitry, thus making the PoE hub inefficient.

### SUMMARY OF THE INVENTION

Accordingly, it is a principal objective of the present invention is to overcome the major disadvantages of prior art by providing an inexpensive and efficient means to power two PD's over a single network cable. The invention includes a method and an apparatus, each with several embodiments, described below.

In one embodiment the method includes steps of: DC-coupling power from a first Power Sourcing Equipment (PSE) port to a first Powered Device (PD); DC-coupling power from a second PSE port to a second PD; AC-coupling data signals from the first PSE port to an Ethernet hub or switch circuit; and AC-coupling differential-mode data signals from both PD's to the Ethernet hub or switch circuit.

In another embodiment the method is as described above, but with the addition of a continuously repeating cycle including steps of: powering the Ethernet hub or switch circuit from the first PSE port; and then powering the Ethernet hub or switch circuit from the second PSE port. The time duration of each if these steps is long enough to allow a PSE to detect that the PD it powers has been disconnected. The cycles starts when at least one of the PSE ports powers a PD, and the cycles stop when neither is the PSE ports is powering a PD.

One embodiment of the apparatus includes: a first connector, providing an interface to a computer network; a second connector, providing an interface to a first PD; a third connector, providing an interface to a second PD; a plurality of transformers; and an Ethernet hub circuit with three ports. The transformers are disposed to AC-couple differential-mode data signals between the Ethernet hub or switch circuit and at least two of the connectors; the transformers also providing DC isolation between the hub or switch and connectors. All three connectors include a first group of contacts and a second group of contacts. The apparatus also includes connection pathways that: a) DC-couple power from the first group of contacts on the first connector, to the first group of contacts on the second connector; and b) DC-couple power from the second group of contacts on the first connector, to either the first or second group of contacts on the third connector.

In one embodiment of the apparatus, the Ethernet hub or switch circuit is passive.

In another embodiment of the apparatus, the Ethernet hub or switch circuit is active, and the apparatus further includes: a power supply that powers the Ethernet hub or switch circuit; and a switching circuit with at least three states. In a first state, the switching circuit routes power from the first group of contacts on the first connector to the input of the power supply; in a second state, the switching circuit routes power from the second group of contacts on the first connector to the input of the power supply; and in a third state the switching circuit is open, carrying no power. The switching circuit continuously alternates between the first and seconds states whenever at least one PSE port is powering a PD; in the time duration spent in each state is longer than the maximum required by a PSE port to determine that the PD it was powering has been disconnected.

### BRIEF DESCRIPTION OF THE DRAWINGS

For a more complete understanding of the invention and to show how the same may be carried into affect, reference will now be made, purely by way of example, to the accompanying drawings:

FIG. 1 shows a block diagram of a system that is an example of prior art;

FIG. 2 shows a block diagram of a novel system utilizing the present invention;

FIG. 3 shows a simplified schematic of one embodiment of the present invention, with a passive Ethernet hub;

FIG. 4 shows more detail of the passive hub of FIG. 3;

FIG. 5 shows a simplified schematic of another embodiment of the present invention, with a passive Ethernet hub;

FIG. 6 shows a simplified schematic of another embodiment, with an active Ethernet hub.

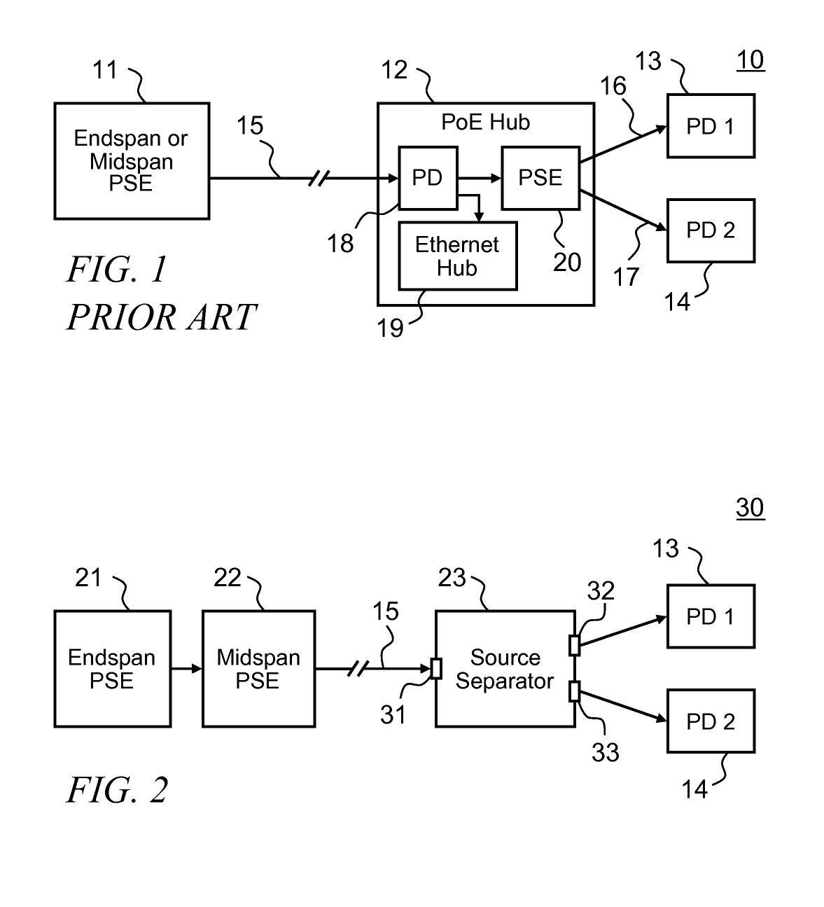

### DETAILED DESCRIPTION OF EXAMPLE EMBODIMENTS OF THE INVENTION

FIG. 2 depicts a novel system 30 in accordance with the teachings of the invention. Network cable 15 carries power from both PSE'S: the endspan PSE 21 sources power on two of the twisted-pairs within 15; and the midspan PSE 22 sources power on the other two twisted-pairs within 15. The source separator apparatus 23 separates power from the two sources: the endspan PSE 21 powers the first PD 13; and the midspan PSE 22 powers the second PD 14.

Some major advantages of the present invention over the prior art are lower cost, and higher efficiency. The cost is lower because the source separator 23 doesn't require an internal PD or PSE, or the associated circuitry such as a DC/DC converter to provide isolation and maintain voltage regulation. Efficiency is improved because power from the endspan PSE 21 and midspan PSE 22 pass directly through the source separator 23 without conversion.

The present invention meets a significant technical challenge: the source separator must include some sort of Ethernet hub (or switch) circuit to allow both PD's to communicate on the computer network, but the power required to run the hub circuit can interfere with the ability of the PSE to sense when a PD has been disconnected. Any power required to run the hub circuit would be interpreted by the remote PSE as a signal that the PD is still connected, and consequently power would remain on after the PD is disconnected. When the PD is subsequently reconnected, the normal detection/classification process would be bypassed, which could cause a variety of power management problems.

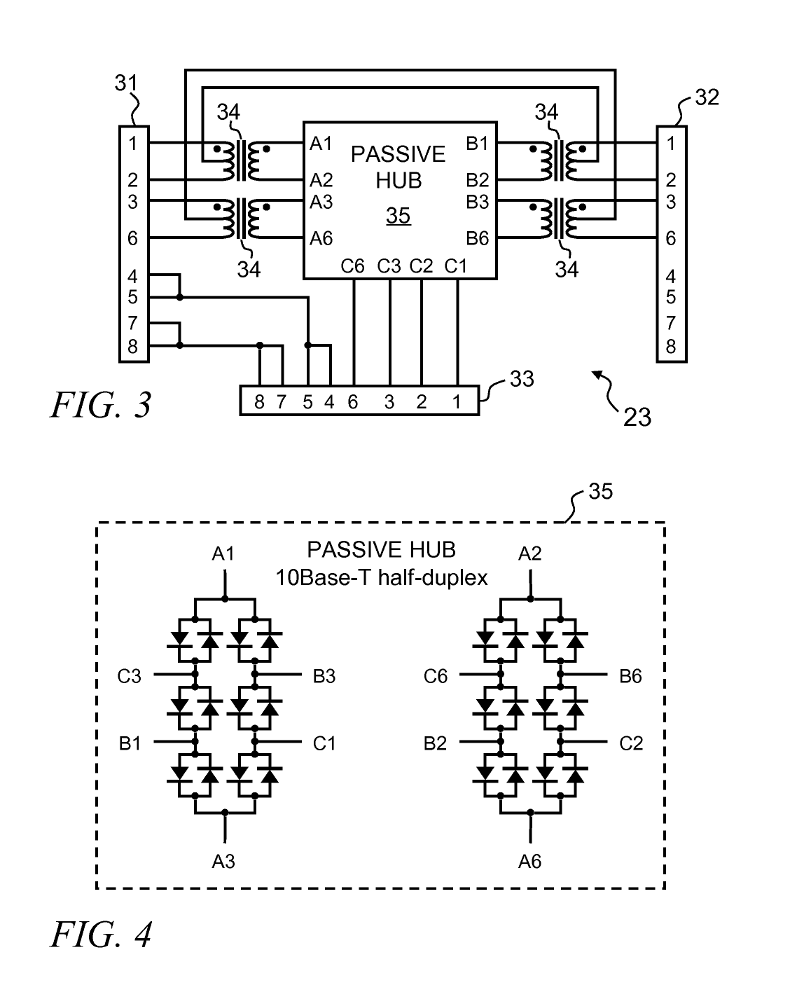

FIG. 3 shows a simplified schematic of one embodiment of the present invention that addresses the problem by using a passive hub 35, which requires no power from either PSE. (In this example and subsequent figures, the connectors 31, 32, and 33 are assumed to be RJ45 type with pin number assignments as specified in the IEEE standard, but the invention is not limited to this particular case.) For simplicity, pins 1, 2, 3, and 6 on any of the connectors will be hereinafter referred to as “Alt-A”, and pins 4, 5, 7 and 8 will hereinafter be referred to as “Alt-B”. (Alt-A and Alt-B are abbreviations for Alternative-A and Alternative-B wiring, which are defined in the IEEE standard.) A first connector 31 receives Ethernet data and power from the endspan PSE 21 on Alt-A, and the power is transferred to PD1 13 via a second connector 32, and the transformers 34. The transformers 34 provide the DC path for the common-mode power, while simultaneously isolating the passive hub circuit 35 from the PSE voltage. Power from the midspan PSE 22 enters on the Alt-B pins of the first connector 31 and exits to PD2 14 on Alt-B pins of a third connector 33.

FIG. 4 shows one embodiment of a passive Ethernet hub circuit 35 of FIG. 3 in greater detail. The diodes provide voltage drops so that any network node that transmits, sees a small signal on its own receiver input; the received signal is below a minimum threshold, therefore the node does not detect a collision. For example, the endspan PSE transmit-data enters the separator 23 on pins 1 and 2 of the first connector 31, passes thru a transformer 34, and thence goes to nodes A1 and A2 on the passive hub circuit 35. The endspan receiver is connected to nodes A3 and A6 on the passive hub 35. The transmitted signal (the voltage between nodes A1 and A2) goes thru six diode drops before getting to the receiver (the voltage between nodes A3 and A6). Therefore, the received signal will be too small to register, and the endspan will not see it as a collision. However, the signal from the endspan goes through only two diode drops before arriving at the receivers for PD1 13 and PD2 14, so the amplitude is still within the sensitivity of those receivers. Because the passive hub is electrically symmetrical, each of the three nodes (PSE, PD1, and PD2) is able to talk to the other two nodes without seeing its own transmissions as collisions.

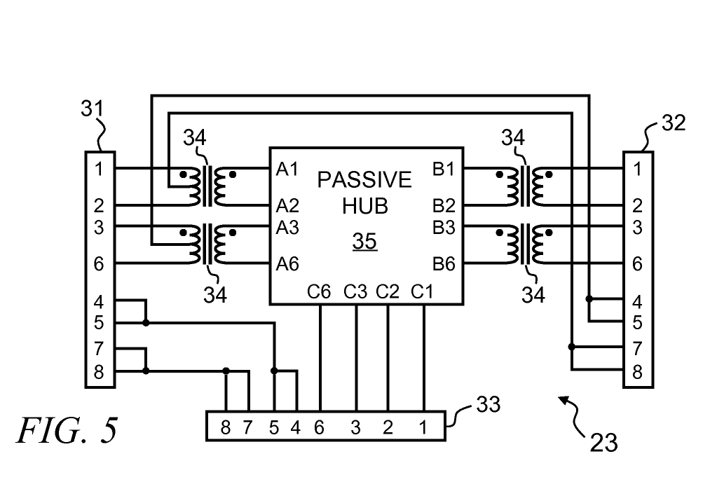

FIG. 5 shows another embodiment of the apparatus, similar to the one of FIG. 4, but with the DC-coupling changed so that power from the Alt-A contacts of connector 31 is coupled to the Alt-B contacts of connector 32. This configuration is slightly more efficient that the circuit of FIG. 4 because the power passes through only one transformer instead of two: the losses due to winding resistance are cut in half. However, the apparatus of FIG. 5 may not work in every situation because the IEEE standard allows the voltage on Alt-A to be of either polarity, while requiring a fixed polarity on Alt-B: some PD's might not use full-wave rectification on their Alt-B inputs, and so would be unable to draw power if the endspan PSE polarity was incompatible. However, the problem can be easily solved by using a cross-over cable.

The example passive hub circuit of FIG. 4 has the advantage of being extremely inexpensive and simple, but has very limited performance: it does nothing to match the characteristic impedances of the cables, and data integrity can be affected by reflections. Therefore the system is limited to 10 Mbps, half-duplex.

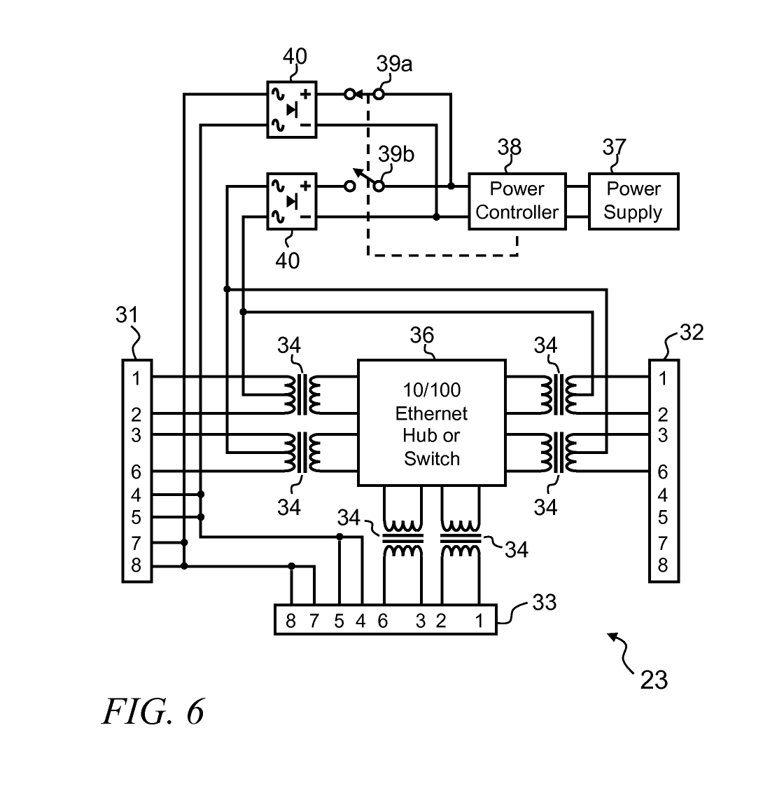

FIG. 6 shows a simplified schematic of another embodiment of the apparatus which overcomes the performance limitations of the previous embodiments. The active Ethernet hub (or Ethernet switch) 36 could support both 10 Base-T and 100 Base-Tx with full-duplex and autonegotiation; however, the power consumed by the active hub/switch circuit 36 must not interfere with the ability of either PSE to sense when the PD it powers has been disconnected. The apparatus of FIG. 6 addresses this issue by alternately powering the hub 36 from Alt-A, then Alt-B, then Alt-A again, etc.

The two bridge rectifiers 40 allow power to be drawn from either endspan PSE 21 or midspan PSE 22 via the first connector 31. Power passes through the switches 39a and 39b, and thence through a power controller 38 before going into the power supply 37 which provides power to run the active hub/switch 36. Initially, before power-up, both switches (39a and 39b) are open, so as not to interfere with the PD detection process of either PSE. One of the remote PSE's detects the presence of a valid PD (connected to 32 or 33) and turns on power. When the voltage on the output of either bridge rectifier 40 exceeds a predetermined threshold, 30V for example, then the corresponding switch closes. The power controller 38 limits the inrush current into the power supply 37. After power supply 37 comes up, the power controller 38 starts to toggle the switches with approximately 50% duty cycle and complementary phases, so that the power supply 37 alternates between drawing power from the endspan PSE 21, and drawing power from the midspan PSE 22. The purpose of the toggling action is to allow a PSE to sense when a PD has been disconnected; each switch has an off-time longer than 400 ms, the maximum maintain-signature dropout time specified in the IEEE standard. The power supply 37 must include sufficiently large holdup capacitance to maintain operation of the hub/switch 36 during this off-time, in case only one PSE is supplying power.

Although the present invention has been described with several embodiments, a myriad of changes, variations, alterations, transformations, and modifications may be suggested by one skilled in the art, and it is intended that the present invention encompass such changes, variations, alterations, transformations, and modifications as they fall within the scope of the appended claims. Some examples of changes, variations, alterations, transformations, and modifications are: additional transformers and logic to make the apparatus of FIG. 6 support gigabit Ethernet; using center-tapped chokes for DC-coupling or power, to reduce current imbalances in the transformers; adding a switch to the schematic of FIG. 5 to allow the user to select the voltage polarity on the Alt-B contacts of connector 32; changing the DC-coupling path in FIG. 6 to go from Alt-A on connector 31 to Alt-B on connector 32, similar to FIG. 5; or including common-mode chokes or terminations to reduce conducted and/or radiated emissions.

What is claimed is:

1. A method for separating power supplied by two Power Sourcing Equipment (PSE) ports on the same network cable to power two Powered Devices (PD), said method comprising steps of:
DC-coupling power from a first PSE port to a first PD;
DC-coupling power from a second PSE port to a second PD;
AC-coupling data signals from said first PSE port to an Ethernet hub or switch circuit; and
AC-coupling data signals from said first PD and said second PD to said Ethernet hub or switch circuit.

2. The method of claim 1 and further comprising a continuously repeating cycle, said cycle comprising steps of:
powering said Ethernet hub or switch circuit from said first PSE port, for a duration longer than the maximum time required by said second PSE port to determine if said second PD has been disconnected; and then
powering said Ethernet hub or switch circuit from said second PSE port, for a duration longer than the maximum time required by said first PSE port to determine if said first PD has been disconnected.

3. The method of claim 2 wherein said cycle starts after said first PSE port is powering said first PD, or said second PSE port is powering said second PD; said cycle stops when neither said PSE port is powering a PD; and said Ethernet hub or switch circuit draws no power from either said PSE port while said cycle is stopped.

4. An apparatus for separating power supplied from two PSE ports on one network cable, the apparatus comprising:
a first network interface connector providing an interface to said network cable, said first network interface connector including a first group of contacts where power is received from said first PSE port, and a second group of contacts where power is received from said second PSE port;
a second network interface connector providing an interface a first PD, said second network interface connector including a first group of contacts and a second group of contacts;
a third network interface connector providing an interface to a second PD, said third network interface connector including a first group of contacts and a second group of contacts;
an Ethernet hub or switch circuit with three ports, said Ethernet hub or switch circuit operable to convey network data between said three network interface connectors;
a plurality of transformers disposed to AC-couple differential-mode data signals between said Ethernet hub or switch circuit and at least two of said network interface connectors, said transformers also providing DC isolation between said hub or switch circuit and at least two of said three network interface connectors; and
circuit pathways that DC-couple power from said second group of contacts on said first network interface connector, to said second group of contacts on said third network interface connector.

5. The apparatus of claim 4, and further comprising circuit pathways that DC-couple power from said first group of contacts on said first network interface connector, to said first group of contacts on said third network interface connector.

6. The apparatus of claim 4, and further comprising circuit pathways that DC-couple power from said first group of contacts on said first network interface connector, to said second group of contacts on said third network interface connector.

7. The apparatus of claim 4 wherein said Ethernet hub or switch circuit is passive.

8. The apparatus of claim 4 wherein said Ethernet hub or switch circuit is active and said apparatus further comprises a power supply that powers said Ethernet hub or switch circuit.

9. The apparatus of claim 8 and further comprising a power switching circuit with at least three states:
a first state wherein said power switching circuit routes power from said first group of contacts on said first network interface connector to the input of said power supply;
a second state wherein said power switching circuit routes power from said second group of contacts on said first network interface connector to the input of said power supply; and
a third state (open state) wherein said power switching circuit routes no power to said power supply from said first network interface connector.

10. The apparatus of claim 9 wherein said power switching circuit remains in said third state whenever said first PSE port is not powering said first PD, and said second PSE port is not powering said second PD.

11. The apparatus of claim 9 wherein said power switching circuit continuously cycles between said first state and said second state whenever at least one of said PSE ports is powering a PD; the time duration spent in each of said first or second states being longer than the maximum time required by a PSE port to determine that the PD it was powering has been disconnected.
